(19) United States
(12) Patent Application Publication
(10) Pub. No.: US 2022/0369572 A1
(43) Pub. Date: Nov. 24, 2022

(54) A PLANT CLIMBING COLUMN

(71) Applicant: Hongjie Zhang, Wuxi (CN)

(72) Inventor: Hongjie Zhang, Wuxi (CN)

(21) Appl. No.: 17/635,860

(22) PCT Filed: Apr. 27, 2021
(86) PCT No.: PCT/CN2021/090135

§ 371 Date: Feb. 16, 2022

(51) Int. Cl. A01G 9/12

(52) U.S. Cl. CPC A01G 9/124

(57) ABSTRACT

The present invention discloses a plant climbing column, comprising a climbing column body, in which a receiving hole is arranged, and at least one end of the receiving hole is open; a connecting component, arranged at the open end of the receiving hole so that the connecting component is detachably connected to the climbing column body. The connecting component can enclose the open end of the receiving hole. The present invention can improve the convenience for the use of plant climbing columns.

### FIELD OF THE INVENTION

The present invention relates to the technical field of green plant cultivation, in particular to a plant climbing column.

### BACKGROUND OF THE INVENTION

Traditional vine plant climbing columns are classified into two types: one is those which have fixed sizes and cannot be adjusted according to the climbing height of plants in their different growth cycles, and the other is those which are segmented and can be extended according to the climbing height of plants with their growth. However, current segmented climbing columns are structured by fixedly connecting rod to climbing column body. If one end of the connecting rod is designed with a pointed tip, it would easily puncture the packaging during transportation.

### SUMMARY OF THE INVENTION

The present invention provides a plant climbing column which can improve the convenience for the use of plant climbing columns.

To solve the above technical problem, the present invention provides a plant climbing column, comprising:

a climbing column body, in which a receiving hole is arranged, and at least one end of the receiving hole is open;

a connecting component, arranged at the open end of the receiving hole so that the connecting component is detachably connected to the climbing column body, and the connecting component can enclose the open end of the receiving hole;

an inserting component, used for inserting into the soil where plants are cultivated. The inserting component can be connected to the climbing column body and can be in the first position and the second position relative to the climbing column body. When the inserting component is in the first position, the inserting component is detachably connected to the connecting component so that the inserting component is positioned relative to the climbing column body. When the inserting component is in the second position, the inserting component is located in the receiving hole.

As preferred for the above technical scheme, the number of the climbing column bodies, connecting components and inserting components is at least two, respectively. The receiving hole is a central hole arranged in the length direction of the climbing column body. Two connecting components are respectively arranged at both ends of the first climbing column body, and two inserting components are respectively connected to the two connecting components. Any one of the two connecting components is inserted in the central hole of the second climbing column body.

As preferred for the above technical scheme, the climbing column body comprises a cylinder. A coating layer is arranged on the external surface of the cylinder. The coating layer is made of soft material.

As preferred for the above technical scheme, the coating layer is made of coconut fiber or hemp.

As preferred for the above technical scheme, the coconut fiber or hemp is tied by rope and arranged on the external surface of the cylinder. The rope is in a spiral shape.

As preferred for the above technical scheme, the connecting component is a connecting sleeve. The connecting sleeve has an open end and a closed end. When the connecting sleeve is connected to the climbing column body, the connecting sleeve is inserted into the receiving hole and the open end is arranged towards the outside. The closed end of the connecting sleeve is used to close the receiving hole. When the inserting component is connected to the connecting sleeve, the inserting component is inserted into the open end of the connecting sleeve.

As preferred for the above technical scheme, the connecting sleeve is a plastic elastic sleeve.

As preferred for the above technical scheme, the inserting component is made of wood or plastic.

As preferred for the above technical scheme, the rope is made of cotton or yarn.

As preferred for the above technical scheme, the first end of the inserting component is sharp, and the second end of the inserting component is straight. The straight end is connected to the connecting sleeve.

The present invention provides a plant climbing column, comprising climbing column bodies, connecting components and inserting components. The climbing column bodies support the twining growth of vine plants. The inserting components are inserted in cultivation soil to position the overall structure. When in use, the connecting components are installed on the climbing column bodies, and the inserting components are installed on the connecting components. When not in use, the inserting components are removed from the connecting components which are removed from the climbing column bodies, and the inserting components are placed in the receiving hole of the climbing column bodies. Then, the connecting components are re-installed at the open end of the receiving hole so that the inserting components are closed in the receiving hole, which can shorten the length of the overall structure, prevent the inserting components from loss, and can also facilitate packaging, transportation and carrying during use.

The above description only provides an overview of the technical scheme of the present invention. In order to have a clearer understanding of the technical means of the present invention for implementation in accordance with the content of the specification, and to make more obvious and understandable the above and other objectives, features and advantages of the present invention, the specific embodiments of the present invention are proposed below.

### BRIEF DESCRIPTION OF THE DRAWINGS

FIG. 1 shows a three-dimensional exploded diagram of a plant climbing column in an embodiment of the present invention;

FIG. 2 shows a three-dimensional structural diagram of the climbing column body in an embodiment of the present invention;

FIG. 3 shows a connection structure diagram of two climbing column bodies in an embodiment of the present invention;

Description of the Reference Numerals: 10. Climbing column body; 20. Connecting component; 30. Inserting component; 101. Cylinder; 102. Coating layer; 103. Rope; 104. Receiving hole

### DETAILED DESCRIPTION OF PREFERRED EMBODIMENT

To make the objectives, features and advantages of the present invention more obvious and understandable, the technical solutions provided in the embodiment of the present invention will be described clearly and completely below in accordance with the drawings in the embodiment of the present invention. Apparently, the described embodiment is merely a part rather than all of the embodiments of the present invention. All other embodiments made by those of skill in the art based on the embodiment of the present invention without creative work shall fall within the protection scope of the present invention.

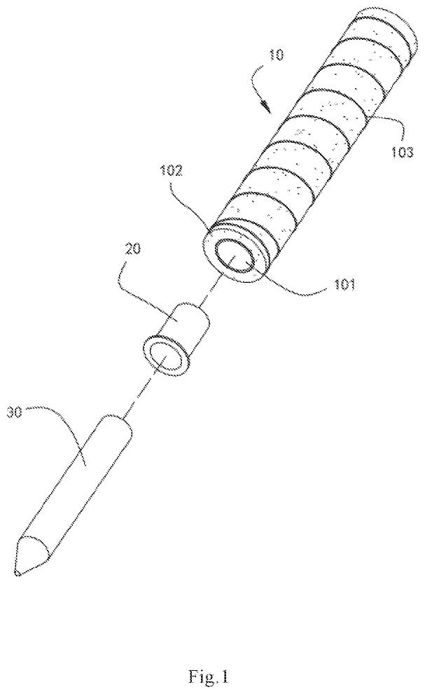

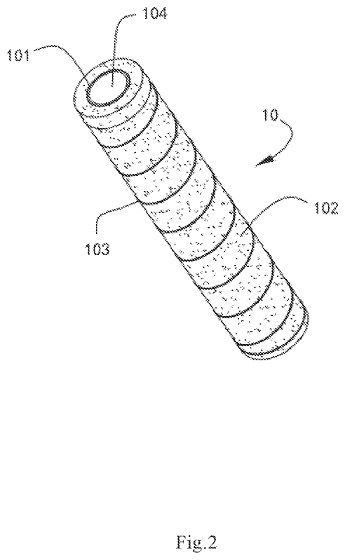

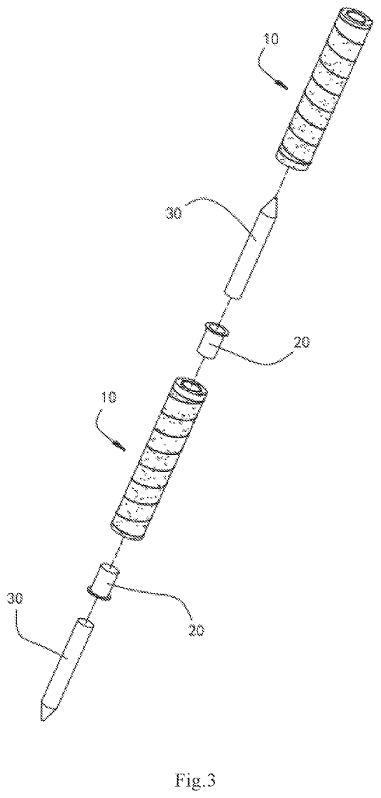

As shown in FIGS. 1-3, the present invention provides a plant climbing column, characterized in that it comprises:

the climbing column body 10, in which the receiving hole 104 is arranged, and at least one end of the receiving hole 104 is open;

the connecting component 20, arranged at the open end of the receiving hole 104 so that the connecting component 20 is detachably connected to the climbing column body 10, and the connecting component 20 can enclose the open end of the receiving hole 104;

the inserting component 30, used for inserting into the soil where plants are cultivated. The inserting component 30 can be connected to the climbing column body 10 and can be in the first position and the second position relative to the climbing column body 10. When the inserting component 30 is in the first position, the inserting component 30 is detachably connected to the connecting component 20 so that the inserting component 30 is positioned relative to the climbing column body 10. When the inserting component 30 is in the second position, the inserting component 30 is located in the receiving hole 104.

This embodiment provides a plant climbing column, comprising climbing column bodies 10, connecting components 20 and inserting components 30. The climbing column bodies 10 support the twining growth of vine plants. The inserting components 30 are inserted in cultivation soil to position the overall structure. When in use, the connecting components 20 are installed on the climbing column bodies 10, and the inserting components 30 are installed on the connecting components 20. When not in use, the inserting components 30 are removed from the connecting components 20 which are removed from the climbing column bodies 10, and the inserting components 30 are placed in the receiving hole 104 of the climbing column bodies 10. Then, the connecting components 20 are re-installed at the open end of the receiving hole 104 so that the inserting components 30 are closed in the receiving hole 104, which can shorten the length of the overall structure, prevent the inserting components 30 from loss, and can also facilitate packaging, transportation and carrying during use.

Further, in one implementation of this embodiment, the number of the climbing column bodies 10, connecting components 20 and inserting components 30 is at least two, respectively. The receiving hole 104 is a central hole arranged in the length direction of the climbing column body 10. Two connecting components 20 are respectively arranged at both ends of the first climbing column body 10, and two inserting components 30 are respectively connected to the two connecting components 20. Any one of the two connecting components 20 is inserted in the central hole of the second climbing column body 10.

In this embodiment, at least two climbing column bodies 10 are available, and their overall height can be adjusted based on the growth of green plants to adapt to their growth. In addition, the second climbing column body 10 in this embodiment is easily installed and removed.

Further, in one implementation of this embodiment, the climbing column body 10 comprises the cylinder 101, the coating layer 102 is arranged on the external surface of the cylinder 101, and the coating layer 102 is made of soft material.

In this embodiment, the coating layer 102 is arranged to be more easily twined by plants, and the soft material of which the coating layer 102 is made can better protect green plants and prevent them from damage.

Further, in one implementation of this embodiment, the coating layer 102 is made of coconut fiber or hemp.

In this embodiment, the coating layer 102 made of coconut fiber or hemp is more easily twined by plants. In addition, the coconut fiber or hemp is closer to natural planting environment and more environmentally friendly.

Further, in one implementation of this embodiment, the coconut fiber or hemp is tied by the rope 103 and arranged on the external surface of the cylinder 101. The rope 103 is in a spiral shape.

In this embodiment, the coconut fiber or hemp is tied by the rope 103 and arranged on the external surface of the cylinder 101 so that the coconut fiber or hemp is more easily installed. In addition, the rope 103 is in a spiral shape so that the coconut fiber or hemp is fixed more firmly and stably. Furthermore, the rope 103 is spiral so that spiral dents are left on the surface of the coconut fiber or hemp, which can guide and protect the twining growth of green plants.

Further, in one implementation of this embodiment, the connecting component 20 is a connecting sleeve, and the connecting sleeve has an open end and a closed end. When the connecting sleeve is connected to the climbing column body 10, the connecting sleeve is inserted into the receiving hole 104 and the open end is arranged towards the outside. The closed end of the connecting sleeve is used to close the receiving hole 104. When the inserting component 30 is connected to the connecting sleeve, the inserting component 30 is inserted into the open end of the connecting sleeve.

In this embodiment, the connecting component 20 is a connecting sleeve, which makes the overall structure simple, and achieves detachable connection between the climbing column body 10 and the inserting component 30 more easily.

Further, in one implementation of this embodiment, the connecting sleeve is a plastic elastic sleeve.

In this embodiment, the connecting sleeve is a plastic elastic sleeve for easy installation and removal. Especially, as an intermediate connector between the climbing column body 10 and the inserting component 30, it can improve the stability of the connection between the two.

Further, in one implementation of this embodiment, the inserting component 30 is made of wood or plastic.

In this embodiment, the inserting component 30 is made of wood, which is closer to natural planting environment and is more environmentally friendly.

Further, in one implementation of this embodiment, the rope 103 is made of cotton or yarn.

In this embodiment, the rope 103 is made of cotton or yarn, which is closer to natural planting environment and is more environmentally friendly.

Further, in one implementation of this embodiment, the first end of the inserting component 30 is sharp, the second end of the inserting component 30 is straight, and the straight end is connected to the connecting sleeve.

In this embodiment, the first end of the inserting component 30 is sharp and can be inserted into cultivation soil with less effort, while the straight end is more easily connected to the connecting sleeve with more stability.

In the description of the present specification, reference terms “one embodiment”, “some embodiments”, “an example”, “a specific example”, or “some examples” etc., mean that particular features, structures, materials, or characteristics described in the embodiment or example are included in at least one embodiment or example of the present invention. Furthermore, the particular features, structures, materials, or characteristics described may be combined in any one or more of the embodiments or examples in a suitable manner. In addition, those skilled in the art can combine and constitute the different embodiments or examples as well as the features of the different embodiments or examples described in this specification without contradicting each other.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include at least one of the features. In the description of the present invention, “more” means two or more than two, unless otherwise specifically defined.

The above are only specific embodiments of the present invention, but the protection scope of the present invention is not limited thereto. Any person skilled in the art can easily think of changes or replacement within the technical scope disclosed by the present invention, which shall be covered within the protection scope of the present invention. Therefore, the protection scope of the present invention shall be subject to the protection scope of the claims.

What is claimed is:

1. A plant climbing column, characterized in that it comprises:
a climbing column body, in which a receiving hole is arranged, and at least one end of the receiving hole is open;
a connecting component, arranged at the open end of the receiving hole so that the connecting component is detachably connected to the climbing column body, and the connecting component can enclose the open end of the receiving hole;
an inserting component, used for inserting into the soil where plants are cultivated. The inserting component can be connected to the climbing column body and can be in the first position and the second position relative to the climbing column body. When the inserting component is in the first position, the inserting component is detachably connected to the connecting component so that the inserting component is positioned relative to the climbing column body. When the inserting component is in the second position, the inserting component is located in the receiving hole.

2. The plant climbing column according to claim 1, wherein the number of the climbing column bodies, connecting components and inserting components is at least two, respectively. The receiving hole is a central hole arranged in the length direction of the climbing column body. Two connecting components are respectively arranged at both ends of the first climbing column body, and two inserting components are respectively connected to the two connecting components. Any one of the two connecting components is inserted in the central hole of the second climbing column body.

3. The plant climbing column according to claim 1, wherein the climbing column body comprises a cylinder. A coating layer is arranged on the external surface of the cylinder. The coating layer is made of soft material.

4. The plant climbing column according to claim 3, wherein the coating layer is made of coconut fiber or hemp.

5. The plant climbing column according to claim 4, wherein the coconut fiber or hemp is tied by rope and arranged on the external surface of the cylinder. The rope is in a spiral shape.

6. The plant climbing column according to claim 1, wherein the connecting component is a connecting sleeve. The connecting sleeve has an open end and a closed end. When the connecting sleeve is connected to the climbing column body, the connecting sleeve is inserted into the receiving hole and the open end is arranged towards the outside. The closed end of the connecting sleeve is used to close the receiving hole. When the inserting component is connected to the connecting sleeve, the inserting component is inserted into the open end of the connecting sleeve.

7. The plant climbing column according to claim 6, wherein the connecting sleeve is a plastic elastic sleeve.

8. The plant climbing column according to claim 1, wherein the inserting component is made of wood or plastic.

9. The plant climbing column according to claim 5, wherein the rope is made of cotton or yarn.

10. The plant climbing column according to claim 6, wherein the first end of the inserting component is sharp, and the second end of the inserting component is straight. The straight end is connected to the connecting sleeve.
